(19) United States
(12) Patent Application Publication
(10) Pub. No.: US 2014/0333180 A1
(43) Pub. Date: Nov. 13, 2014

(54) PIEZOELECTRIC ACTUATION DEVICE

(71) Applicant: CSIR, Pretoria (ZA)

(72) Inventors: Edward Francis Williams, Pretoria (ZA); Philip Wayne Loveday, Midrand (ZA)

(21) Appl. No.: 14/358,617

(22) PCT Filed: Nov. 7, 2012
(86) PCT No.: PCT/IB2012/056210

§ 371 Date: May 15, 2014

(30) Foreign Application Priority Data
Nov. 15, 2011 (ZA) 2011/08377

(51) Int. Cl. H02N 2/02; H02N 2/04

(52) U.S. Cl. CPC H02N 2/023; H02N 2/043
USPC 310/323.02

(57) ABSTRACT

THIS invention relates to a piezoelectric actuation device and more particularly but not exclusively, to a piezoelectric actuation device with three piezoelectric actuator sets. The device includes a first clamp arrangement being displaceable between an engaged position and a disengaged position and a second clamp arrangement being displaceable between an engaged position and a disengaged position. The device also includes an actuation arrangement being displaceable between a first condition and an inverse second condition; and force transmission means for transmitting a force to a load applied thereto, with the force transmission means being coupled to the actuation arrangement. The device is characterized in that the actuation arrangement displaces the force transmission means when it is displaced from the first condition to the second condition, and also displaces the same force transmission means when it is displaced from the second condition to the first condition within a single actuating cycle.

### RELATED APPLICATIONS

This application is a United States National Stage Application filed under 35 U.S.C 371 of PCT Patent Application Serial No. PCT/IB2012/056210, filed Nov. 7 2012, which claims South African Patent Application Serial No. 2011/08377, filed Nov. 15, 2011, the disclosure of all of which are hereby incorporated by reference in their entirety.

### BACKGROUND TO THE INVENTION

THIS invention relates to a piezoelectric actuation device and more particularly but not exclusively, to a piezoelectric actuation device with three piezoelectric actuator sets.

Piezoelectricity is the ability of some materials to generate an electrical potential when a pressure is applied. The effect is reversible in that when an electrical field is applied, a mechanical stress and/or strain are produced.

The high force density and good dynamic properties of piezoelectric materials make them attractive technology for use in actuator applications. However, the very small displacement associated therewith limits their usefulness. To increase the displacement, mechanical amplification may be used by attaching a lever to an actuator. This, however, reduces the force capability.

Another possibility is to use so-called ‘frequency levering’ where an actuator is driven dynamically at a high frequency and displacement per cycle is added over many repetitions, without compromising on the force capability. One such a mechanism that accumulates a number of small displacements is known as a piezoelectric actuated motor, which is more commonly known in the trade as an inchworm motor. An inchworm motor therefore utilizes piezoelectric actuators that displace a load with precision stepwise movements.

Basically, an inchworm motor comprises three piezoelectric actuators, or actuator sets, that work together. Two of the actuators act as brakes or clamps, and the third is the extender that produces the forward displacement. The force capability of the motor is the force capacity of the extender actuator, minus any internal compliance of the motor, provided the braking force of the clamp mechanism matches or exceeds the extender force. The travel distance is only limited by the guide of the motor. The inchworm motor principle is useful in multiplying the small displacement of piezoelectric materials, but is not limited to such materials. Inchworm motors may also consist of amongst others, electromagnetic technologies.

Linear motors utilizing the inchworm principle may have different embodiments that can be broadly grouped into three groups:

Both clamps and extender is connected directly. This group includes configurations where the clamps and extender are mounted to a common base or are attached directly to form a single unit. This unit may be stationary, and may displace a shaft or a guide, or the shaft or guide may be stationary and the clamps-extender unit moves. The extender causes the clamps to be displaced relative to each other with each step.

The second grouping includes configurations where the clamps are separate from the extender but both clamps are connected to each other or mounted to a common base. The extender may be part of the guide or shaft and cause it to extend and contract rather than the clamps. The relative position between the two clamps is fixed.

The third grouping is configurations where only one of the clamps is attached to the extender. The inchworm motion will cause the distance between the clamps to increase or decrease continually as the moving part of the motor travels in the actuation direction.

An embodiment of second inch worm motor group is shown in FIG. 1, and an embodiment of a first inch worm motor group is shown in FIG. 5. Both the prior art inchworm motors 100 include two clamp arrangements 120, and an actuation arrangement 130 located between the clamp arrangements 120. Each clamp arrangement 20 comprises a piezoelectric actuator 121 which can be displaced between extended and retracted positions so as to cause the clamp arrangement 120 to toggle between engaged and disengaged positions. The actuation arrangements 130 also include at least one piezoelectric actuator 131 that can be displaced between an extended and retracted position, in which the displacement between the two opposing positions result in the desired displacement of a load, as is discussed in more detail below.

In the case of the group 2 inchworm motor configuration (FIG. 1), the clamp arrangements 120 remains stationary relative to a frame 110 of the motor 100, whereas the actuation arrangement 130 is displaced relative to the frame 110, and thus the clamp arrangements 120. Two push rods 132 are connected to the actuation arrangement 130, and extend through a clamp formation 122 that is actuated by the actuator 121 of the clamp arrangement 120. In use a first clamp arrangement will engage the one push rod, thus preventing the push rod to be displaced relative to the frame 110. The actuation arrangement will then be actuated, and will result in the two push rods 132 from being urged away or towards one another. The second push rod will therefore be displaced, due to the first push rod being clamped by the clamping arrangement. Once the second push rod has been displaced, the second clamp arrangement will be actuated, and will engage the second push rod, while the first clamp arrangement will disengage the first push rod. When the actuation arrangement is subsequently displaced to its original position, it will cause the push rods to be urged towards or away from one another. The second push rod is now clamped, while the first push rod is free to be displaced, thus causing the first push rod to be displaced relative to the frame. By repeating this sequence controlled stepwise displacement is achieved. In the case of the group 1 inch worm motor configuration (FIG. 5) a similar sequence is followed. However, in this configuration the entire inch worm motor travels inside a channel 112 and the clamp arrangement 120 are displaced with the actuation arrangement 130 in a sequential manner. However, the fundamental operating principle remains the same.

In summary, a single cycle of an inchworm motor that comprises two clamps and one extender therefore typically consists of the following steps:

First clamp is inactive while second clamp is engaged.

The extender extends.

First clamp is activated—both clamps are now engaged.

Second clamp is disengaged.

The extender relaxes and compliance in the mechanism or active actuation returns the extender part to its original length/shape.

Second clamp is engaged.

First clamp is disengaged.

After one of these cycles, the motor or a drive shaft has been displaced linearly by a small amount, and the cycle can be repeated. The large bandwidth of typical piezoelectric material allows for this cycle to be repeated with high frequencies. The motor mimics continued linear motion depending on the driving frequencies and step size.

The conventional Inchworm motor design entails that the extender act against the external load once within each operating cycle. The load is displaced the full step size that the extender is capable off. The other event that concerns the extender, is when the extender recovers from the displacement it underwent. During this event, the load is hold by one of the clamps but no work is done externally by the recovering step of the extender. This applies to both the group 2 (FIG. 1) and group 1 (FIG. 5) inchworm motor configurations as well as group 3 embodiments.

The conventional thinking has been that only one end of the extender could be used to do external work with. An inchworm motor that was designed based on the conventional design could be utilised in such a manner that it displace its maximum load at each end of the extender (FIG. 1), i.e. the maximum load could be attached at each end. However, it was realized that the conventional design does not utilise the full load capacity of the inchworm motor.

It is accordingly an object of the invention to provide an inchworm motor that will, at least partially, alleviate the above disadvantage.

It is also an object of the invention to provide an inchworm motor which will be a useful alternative to existing inchworm motors.

### SUMMARY OF THE INVENTION

According to the invention there is provided a piezoelectric actuation device including:

a first clamp arrangement being displaceable between an engaged position and a disengaged position;

a second clamp arrangement being displaceable between an engaged position and a disengaged position;

an actuation arrangement being displaceable between a first condition and an inverse second condition; and

force transmission means for transmitting a force to a load applied thereto, with the force transmission means being coupled to the actuation arrangement,

characterized in that the actuation arrangement displaces the force transmission means when it is displaced from the first condition to the second condition, and also displaces the same force transmission means when it is displaced from the second condition to the first condition within a single actuating cycle.

There is provided for the force transmission means to be configured to act as a fulcrum that enables the magnitude of the transmitted force to be doubled.

The actuation arrangement may include a piezoelectric actuator, a first moving part and a second moving part, in which the first moving part is displaced by the piezoelectric actuator during one actuation event thereof, and in which the second moving part is displaced by the piezoelectric actuator during an opposite actuation event thereof.

The first moving part and the second moving may be secured to the actuator arrangement at opposing sides of the piezoelectric actuator.

The first moving part and the second moving part may be integrally formed with the actuation arrangement, or may be in the form of separate components that are releasably secured to the actuation arrangement.

The force transmission means may include a proximal zone, which in use engages a load, and two opposing distal zones, with each distal zone being coupled to one of the moving parts of the actuation arrangement.

### BRIEF DESCRIPTION OF THE DRAWINGS

A preferred embodiment of the invention is described by way of a non-limiting example, and with reference to the accompanying drawings in which:

FIG. 1 is a plan view of a group two inch worm motor forming part of the prior art;

FIG. 2 is a plan view of a new group two inch worm motor in accordance with one embodiment of the invention;

FIG. 3 shows a first incremental actuation step of the motor of FIG. 2;

FIG. 4 shows a second incremental actuation step of the motor of FIG. 2;

FIG. 5 is a plan view of a group one inch worm motor forming part of the prior art; and

FIG. 6 is a perspective view of a new group one type inch worm motor in accordance with a further embodiment of the invention.

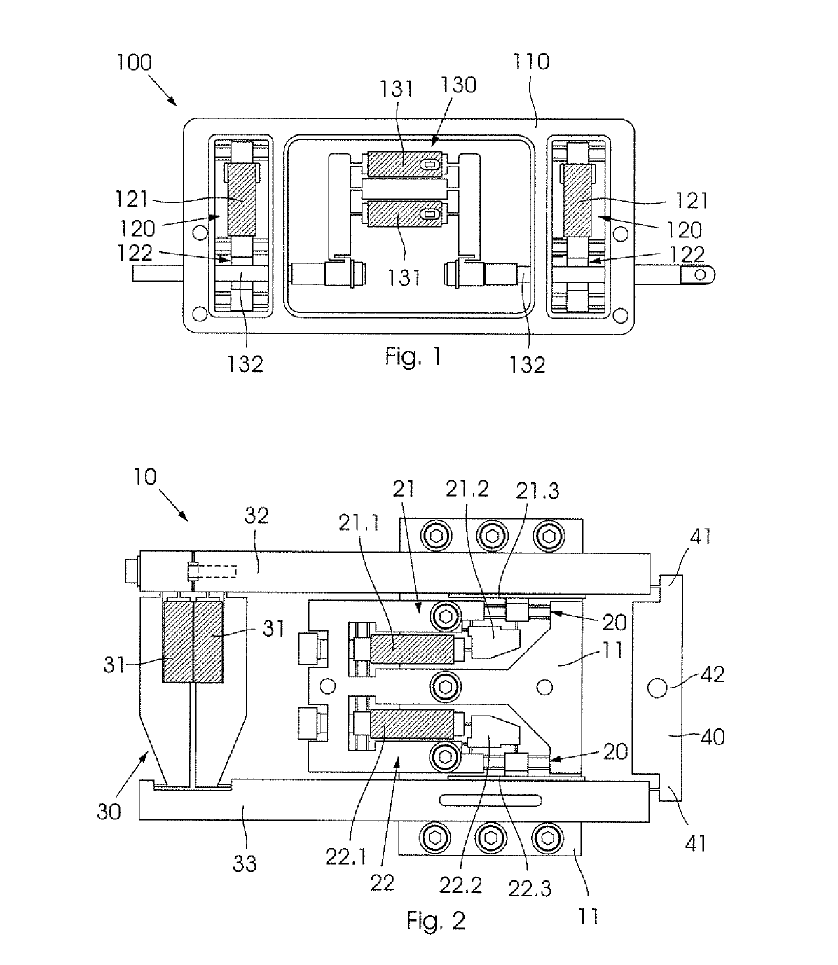

### DETAILED DESCRIPTION OF INVENTION

Referring to FIGS. 2, 3, 4 and 6, in which like numerals indicate like features, non-limiting examples of piezoelectric actuated motors, or inch worm motors, in accordance with the invention is generally indicated by reference numeral 10.

FIGS. 2, 3 and 4 show an embodiment of the invention as applied to a group two inch worm motor, where the actuation arrangement is displaced relative to the frame 11 of the inch worm motor 10. The inch worm motor 10 comprises a first clamp arrangement 21 and a second clamp arrangement 22 that are mounted on a frame 11, and which is displaceable between engaged positions (in which they clamp corresponding parts of the actuation arrangement as described in more detail below) and disengaged positions, in which displacement of such corresponding parts is allowed. Each clamp arrangement (21 or 22) includes a piezoelectric actuator (21.1 and 22.1) which is configured to displace an actuation arm (21.2 and 22.2), which is in turn connected to a clamp formation (21.3 and 22.3).

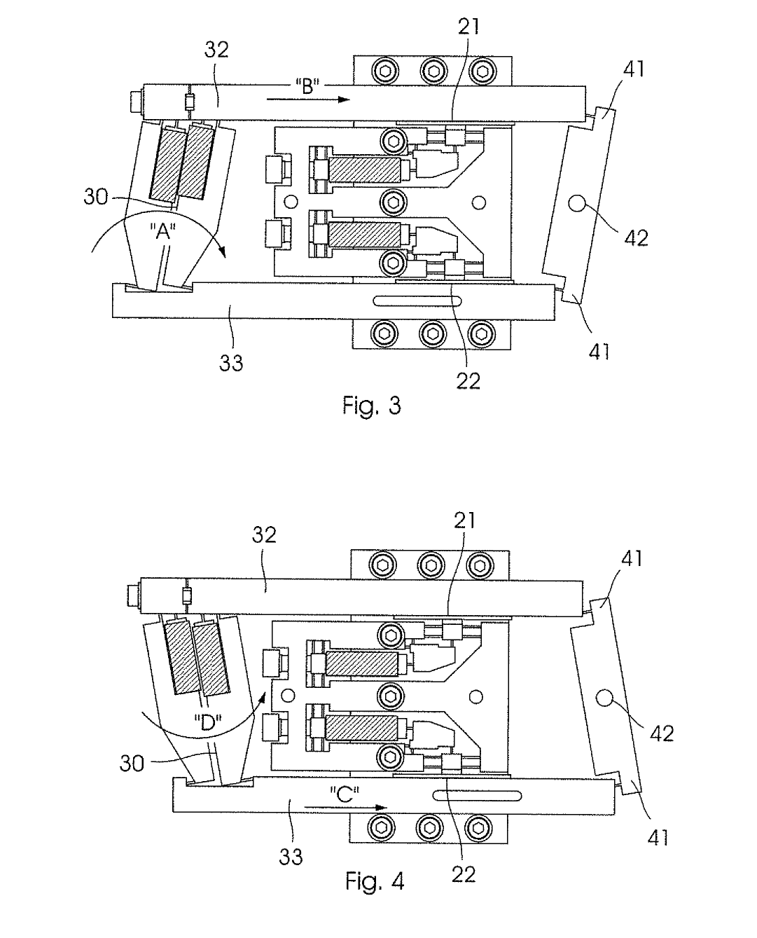

The actuation arrangement 30 of this embodiment is displaceable relative to the clamp arrangements. The actuation arrangement 30 in this embodiment includes a pair of oppositely configured piezoelectric actuators 31. The actuators 31 are configured in order for the one to extend when the other contracts, and vice versa, so as to result in the displacement sequence shown in FIGS. 3 and 4. A first elongate moving part 32 is located towards one end of the actuators 31, and a second elongate moving part 33 is located at an opposite end of the actuators 31. The moving parts (32 and 33) are substantially perpendicular to the actuators 31 and parallel relative to one another, and extend through the stationary frame 11 of the inch worm motor 10. Each moving part passes immediately adjacent a corresponding clamp arrangement, and can therefore selectively be retained in a fixed position when the clamp is displaced from a disengaged position to an engaged position. In this way reciprocating forward movement of the actuation arrangement 30, and in particular the two elongate moving parts (32 and 33) is achieved. A force transmission means 40 is provided, and extends between free ends of the moving parts (32 and 33). The force transmission means 40 includes a proximal zone 41 where a load is transferred to an external object, and two opposing distal zones 42, each of which is pivotably attached to a free end of a moving part (32 and 33). The effect of this configuration is that the stationary moving part (i.e. the one being clamped) acts as a fulcrum, and that the force exerted by the other moving part is therefore doubled. This comes at the expense of reduced displacement, but this compensated for by the double action nature of the inch worm motor configuration, meaning that a moving part is displaced during each displacement of the actuator, as is shown in FIGS. 3 and 4.

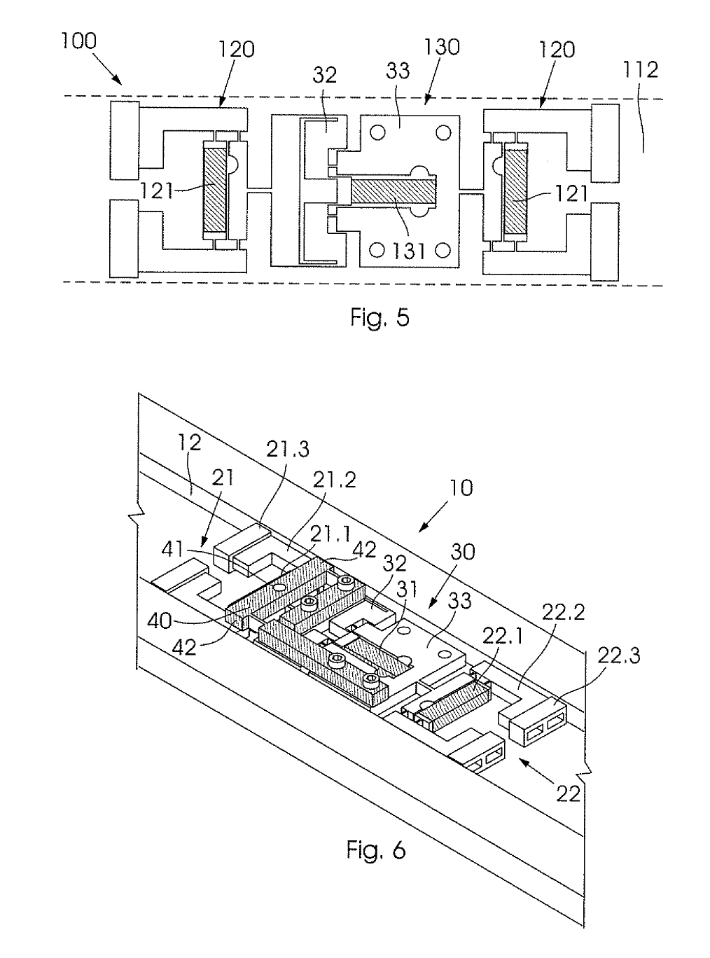

A second embodiment of an inch worm motor in accordance with the invention is shown in FIG. 6. In this case the inch worm motor is of the first grouping, and the invention is implemented utilizing the basic configuration of the prior art group one inch worm motor of FIG. 5. The inch worm motor 10 shown in FIG. 6 comprises two opposing clamp arrangements (21 and 22) with an actuation arrangement 30 located therebetween. In this configuration both the clamp arrangements and the actuation arrangement moves inside a channel 12, and movement is therefore only limited by the length of the channel. The actuation arrangement 30 includes only a single piezoelectric actuator 31, a first end of which is coupled to a first moving part 32 of the actuator arrangement 30, and an opposite second end of which is coupled to a second moving part 33 of the actuator arrangement. It will be appreciated that at least one of the moving parts will be displaced with every displacement of the actuator 31. In the conventional arrangement (shown in FIG. 5) a load will only be displaced during either extension or return of the actuator 31. However, a force transmission means has now been mounted on the conventional arrangement which allows for double action displacement, whilst also resulting in the doubling of exerted force (as was the case for the previous embodiment described above). The force transmission means 40 again includes a proximal zone 41, where the external force is applied, and two distal zones 42. Each distal zone is coupled to one of the moving parts (32 and 33) of the actuation arrangement 30, thus resulting in displacement of the force transmission means with each displacement of the actuator 30.

In both embodiments described above a force can be exerted on an external object on both actions of the piezoelectric actuator. In addition, the force is transmitted by way of a fulcrum configuration that results in doubling of the force. The reduced displacement is offset by the additional displacement achieved during the conventionally stationary cycle, and the net effect is the same displacement as is present in prior art configurations, but with the force having been doubled. The conventional design does not utilise the full load capacity, and this invention combines the loads capacity of both sides of the extender to act against a load twice the magnitude of the maximum load capability of the conventional design, instead of the maximum load for example, for a conventional design, being applied at each end.

A further advantage is that since the step size experienced by the external load is half that of one extender step event, that the step resolution is thus twice as good as for the conventional design i.e. the smallest precision step that the motor can make is half that of a similar conventional design. This is particular important for instances where the IWM is used as a precision actuator, which is one of the typical application for Inchworm motors.

It will be appreciated that the above is only one embodiment of the invention and that there may be many variations without departing from the spirit and/or the scope of the invention.

1. A piezoelectric actuation device including:
a first clamp arrangement being displaceable between an engaged position and a disengaged position;
a second clamp arrangement being displaceable between an engaged position and a disengaged position;
an actuation arrangement being displaceable between a first condition and an inverse second condition; and
force transmission means for transmitting a force to a load applied thereto, with the force transmission means being coupled to the actuation arrangement,
wherein the actuation arrangement displaces the force transmission means when it is displaced from the first condition to the second condition, and also displaces the same force transmission means when it is displaced from the second condition to the first condition within a single actuating cycle;
characterized in that the force transmission means is configured to act as a fulcrum that enables the magnitude of the transmitted force to be doubled.

2. The piezoelectric actuation device of claim 1 in which the actuation arrangement includes a piezoelectric actuator, a first moving part and a second moving part, wherein the first moving part is displaced by the piezoelectric actuator during one actuation event thereof, and wherein the second moving part is displaced by the piezoelectric actuator during an opposite actuation event thereof.

3. The piezoelectric actuation device of claim 2 in which the first moving part and the second moving are secured to the actuator arrangement at opposing sides of the piezoelectric actuator.

4. The piezoelectric actuation device of claim 3 in which the first moving part and the second moving part are integrally formed with the actuation arrangement.

5. The piezoelectric actuation device of claim 3 in which the first moving part and the second moving part are in the form of separate components that are releasably secured to the actuation arrangement.

6. The piezoelectric actuation device of claim 1 in which the force transmission means includes a proximal zone, which in use engages a load, and two opposing distal zones, with each distal zone being coupled to one of the moving parts of the actuation arrangement.

7. The piezoelectric actuation device of claim 2 in which the force transmission means includes a proximal zone, which in use engages a load, and two opposing distal zones, with each distal zone being coupled to one of the moving parts of the actuation arrangement.

8. The piezoelectric actuation device of claim 3 in which the force transmission means includes a proximal zone, which in use engages a load, and two opposing distal zones, with each distal zone being coupled to one of the moving parts of the actuation arrangement.
